(19) United States
(12) Patent Application Publication
(10) Pub. No.: US 2025/0372078 A1
(43) Pub. Date: Dec. 4, 2025

(54) METHODS AND SERVERS FOR TRAINING A MODEL TO PERFORM SPEAKER CHANGE DETECTION

(71) Applicant: Y.E. Hub Armenia LLC, Yerevan (AM)

(72) Inventor: Evgenii GRITSKEVICH, Minsk (BY)

(21) Appl. No.: 19/223,372

(22) Filed: May 30, 2025

(30) Foreign Application Priority Data
May 31, 2024 (RU) 2024114975

(51) Int. Cl. G10L 13/08; G10L 25/30

(52) U.S. Cl. CPC G10L 13/08; G10L 25/30; G10L 2013/083

(57) ABSTRACT

A method and a server for training a model are provided. The method comprises: acquiring a punctuation training dataset including a first input and a first label, the first input including audio data and textual data representative of an utterance, the first label including a sequence of ground-truth tokens, training the model using the punctuation training dataset, thereby generating a punctuation trained model; acquiring a speaker change training dataset including a second input and a second label, the second input including second audio data and second textual data, the second label including a second sequence of ground-truth tokens, fine-tuning the punctuation trained model using the speaker change training dataset, thereby generating a speaker change model; acquiring an in-use textual data and corresponding in-use audio data; and generating, using the speaker change model, the second in-use sequence of tokens based on the in-use audio data and the in-use textual data.

### CROSS-REFERENCE

The present application claims priority to Russian Patent Application No. 2024114975, entitled “Methods and Servers for Training a Model to Perform Speaker Change Detection”, filed May 31, 2024, the entirety of which is incorporated herein by reference.

### FIELD

The present technology relates to audio and text processing and, specifically, to methods and servers for training a model to perform speaker change detection.

### BACKGROUND

Translating speech in a video from an originally recorded language to another language may involve labor-intensive efforts of voice dubbing translated audio portions onto the original video. Dubbing technologies play a role in making content accessible to a global audience by providing dubbing options in different languages. Generally, voice dubbing refers to combining additional or supplementary recordings (dubbed speech) with originally recorded speech to create the finished soundtrack for the video.

Conventional dubbing may be implemented using neural networks configured to recognize speech, convert audio into text, split the recognized text into separate segments, assign sentences to the associated speakers, translate segments into the target language, and generate the dubbed audio which is then overlayed over the original video.

However, the dubbed speech may differ from the originally recorded speech and may not align with start and end times of the originally recorded speech. As a result, the translated audio may appear out of sync and may not be appealing to viewers. The quality of dubbed speech alignment also suffers due to change in different speakers in the originally recorded speech.

Speaker Change Detection (SCD) in dubbing is a technology-driven process that involves identifying and marking transitions between different speakers or actors in an audio and/or video recording. By recognizing when one character's dialogue ends and another's begins, SCD solutions aid in synchronization of dubbed voices with the original footage and/or maintaining lip-sync accuracy.

Certain SCD approaches have been proposed in the prior art.

United States Patent Application Publication No.: 2022/0254,351-A1, published on Aug. 11, 2022, assigned to Works Mobile Japan Corp, and entitled “METHOD AND SYSTEM FOR CORRECTING SPEAKER DIARIZATION USING SPEAKER CHANGE DETECTION BASED ON TEXT,” discloses a method and system for correcting speaker diarization using a text-based speaker change detection. A speaker diarization correction method may include performing speaker diarization on an input audio stream; recognizing speech included in the input audio stream and converting the speech to text; detecting a speaker change based on the converted text; and correcting the speaker diarization based on the detected speaker change.

An article entitled “Speech Recognition and Multi-Speaker Diarization of Long Conversations,” authored by Mao et al., and published on arxiv.org on Nov. 5, 2020, discloses separate training of Automatic Speech Recognition (ASR) and Speaker Diarization (SD) models given known utterance boundaries. Also, the article introduces a striding attention decoding algorithm and data augmentation techniques which, combined with model pre-training, is said to improve ASR and SD.

### SUMMARY

Developers of the present technology have appreciated certain technical drawbacks associated with the existing dubbing services. It is an object of the present technology to ameliorate at least some of the inconveniences present in the prior art.

In at least some embodiments there is provided methods and system for enabling a dubbing engine. Broadly, a dubbing engine is a computer-implement module used in the process of audio “dubbing”, during which synchronized audio tracks are generated in a target language that is different from a source language. For example, the target audio track may be synchronized to lip movements and timing of the original audio in the source language. In some embodiments, the dubbing engine may perform voice morphing for modifying the pitch, tone, and pacing of the dubbed audio to better match the original audio. The dubbing engine may be used in real-time, such as in live broadcasts or video conferencing where immediate dubbing is required, for example, or it may be used in post-production for pre-recorded content.

More specifically, in accordance with a first broad aspect of the present technology, there is provided a method of training a model. The method is executable by a server. The method comprises: acquiring a punctuation training dataset including a first input and a first label, the first input including both audio data and textual data representative of a speaker's utterance, the first label including a sequence of ground-truth tokens, the sequence of ground-truth tokens including (i) a ground-truth text token indicative of a word and (ii) a ground-truth punctuation token indicative of a punctuation, the ground-truth punctuation token positioned after the ground-truth text token; training the model using the punctuation training dataset for generating an in-use sequence of tokens based on a combination of in-use audio data and in-use textual data, thereby generating a punctuation trained model; acquiring a speaker change training dataset including a second input and a second label, the second input including second audio data and second textual data representative of utterance of more than one speaker, the second label including a second sequence of ground-truth tokens, the second sequence of ground-truth tokens including (i) a second ground-truth text token indicative of a second word, (ii) a second ground-truth punctuation token indicative of a second punctuation, and (iii) a ground-truth speaker change token indicative of a change in speakers, the ground-truth speaker change token being positioned after the second ground-truth punctuation token; fine-tuning the punctuation trained model using the speaker change training dataset for generating a second in-use sequence of tokens based on the combination of the in-use audio data and the in-use textual data, thereby generating a speaker change model; acquiring an in-use dataset including both the in-use textual data and the in-use audio data; generating, using the speaker change model, the second in-use sequence of tokens based on the combination of the in-use audio data and the in-use textual data, the second in-use sequence of tokens including an in-use text token, an in-use punctuation token positioned after the in-use text token, and an in-use speaker change token positioned after the in-use punctuation token; and generating a synthetic audio content based on the second in-use sequence of tokens.

In some implementations of the method, the speaker change model includes an audio sub-model, a text sub-model, and a third sub-model, and the generating the second in-use sequence of tokens includes: generating, using the audio sub-model, an in-use sequence of audio embeddings based on the in-use audio data; generating, using the text sub-model, an in-use sequence of text embeddings based on the in-use textual data; generating a concatenated intermediate output using the in-use sequence of audio embeddings and the in-use sequence of text embeddings; and generating, using the third sub-model, the second in-use sequence of tokens using the concatenated intermediate output.

In some implementations of the method, the audio sub-model is a WavLM model.

In some implementations of the method, the text sub-model is a mT5 model.

In some implementations of the method, the third sub-model is a transformer model.

In some implementations of the method, the method further comprises: generating, using a speech-to-text model, the textual data based on the audio data; generating, using the speech-to-text model, the second textual data based on the second audio data; and generating, using a speech-to-text model, the in-use textual data based on the in-use audio data.

In some implementations of the method, the ground-truth punctuation token is positioned immediately after the ground-truth text token; the ground-truth speaker change token is positioned immediately after the second ground-truth punctuation token; the in-use punctuation token is positioned immediately after the in-use text token; and the in-use speaker change token is positioned immediately after the in-use punctuation token.

In accordance with a second broad aspect of the present technology, there is provided a method of fine-tuning a pre-trained model. The method is executable by a server. The method comprises: acquiring a speaker change training dataset including a second input and a second label, the second input including second audio data and second textual data representative of utterance of more than one speaker, the second label including a second sequence of ground-truth tokens, the second sequence of ground-truth tokens including (i) a second ground-truth text token indicative of a second word, (ii) a second ground-truth punctuation token indicative of a second punctuation, and (iii) a ground-truth speaker change token indicative of a change in speakers, the ground-truth speaker change token being positioned after the second ground-truth punctuation token in the second sequence of ground-truth tokens; fine-tuning the pre-trained model using the speaker change training dataset for generating a second in-use sequence of tokens based on a combination of an in-use audio data and an in-use textual data, thereby generating a speaker change model, the pre-trained model having been trained based on a punctuation training dataset for generating an in-use sequence of tokens based on the combination of the in-use audio data and the in-use textual data, the punctuation training dataset including a first input and a first label, the first input including both audio data and textual data representative of a speaker's utterance, the first label including a sequence of ground-truth tokens, the sequence of ground-truth tokens including (i) a ground-truth text token indicative of a word and (ii) a ground-truth punctuation token indicative of a punctuation, the ground-truth punctuation token being positioned after the ground-truth text token; acquiring an in-use dataset including both the in-use textual data and the in-use audio data; generating, using the speaker change model, the second in-use sequence of tokens based on the combination of the in-use audio data and the in-use textual data, the second in-use sequence of tokens including an in-use text token, an in-use punctuation token positioned after the in-use text token, and an in-use speaker change token positioned after the in-use punctuation token; generating a synthetic audio content based on the second in-use sequence of tokens.

In some implementations of the method, the ground-truth punctuation token is positioned immediately after the ground-truth text token; the ground-truth speaker change token is positioned immediately after the second ground-truth punctuation token; the in-use punctuation token is positioned immediately after the in-use text token; and the in-use speaker change token is positioned immediately after the in-use punctuation token.

In accordance with third broad aspect of the present technology, there is provided a server for training a model. The server comprises at least one processor and at least one non-transitory computer-readable memory storing executable instructions, which, when executed by the at least one processor cause the server to: acquire a punctuation training dataset including a first input and a first label, the first input including both audio data and textual data representative of a speaker's utterance, the first label including a sequence of ground-truth tokens, the sequence of ground-truth tokens including (i) a ground-truth text token indicative of a word and (ii) a ground-truth punctuation token indicative of a punctuation, the ground-truth punctuation token positioned after the ground-truth text token; train the model using the punctuation training dataset for generating an in-use sequence of tokens based on a combination of in-use audio data and in-use textual data, thereby generating a punctuation trained model; acquire a speaker change training dataset including a second input and a second label, the second input including second audio data and second textual data representative of utterance of more than one speaker, the second label including a second sequence of ground-truth tokens, the second sequence of ground-truth tokens including (i) a second ground-truth text token indicative of a second word, (ii) a second ground-truth punctuation token indicative of a second punctuation, and (iii) a ground-truth speaker change token indicative of a change in speakers, the ground-truth speaker change token being positioned after the second ground-truth punctuation token; fine-tune the punctuation trained model using the speaker change training dataset for generating a second in-use sequence of tokens based on the combination of the in-use audio data and the in-use textual data, thereby generating a speaker change model; acquire an in-use dataset including both the in-use textual data and the in-use audio data; generate, using the speaker change model, the second in-use sequence of tokens based on the combination of the in-use audio data and the in-use textual data, the second in-use sequence of tokens including an in-use text token, an in-use punctuation token positioned after the in-use text token, and an in-use speaker change token positioned after the in-use punctuation token; and generate a synthetic audio content based on the second in-use sequence of tokens.

In some implementations of the server, the speaker change model includes an audio sub-model, a text sub-model, and a third sub-model, the generating the second in-use sequence of tokens including: generating, using the audio sub-model, an in-use sequence of audio embeddings based on the in-use audio data; generating, using the text sub-model, an in-use sequence of text embeddings based on the in-use textual data; generating a concatenated intermediate output using the in-use sequence of audio embeddings and the in-use sequence of text embeddings; and generating, using the third sub-model, the second in-use sequence of tokens using the concatenated intermediate output.

In some implementations of the server, the audio sub-model is a WavLM model.

In some implementations of the server, the text sub-model is a mT5 model.

In some implementations of the server, the third sub-model is a transformer model.

In some implementations of the server, the at least one processor further causes the server to: generate, using a speech-to-text model, the textual data based on the audio data; generate, using the speech-to-text model, the second textual data based on the second audio data; and generate, using a speech-to-text model, the in-use textual data based on the in-use audio data.

In some implementations of the server, the ground-truth punctuation token is positioned immediately after the ground-truth text token; the ground-truth speaker change token is positioned immediately after the second ground-truth punctuation token; the in-use punctuation token is positioned immediately after the in-use text token; and the in-use speaker change token is positioned immediately after the in-use punctuation token.

In the context of the present specification, a “server” is a computer program that is running on appropriate hardware and is capable of receiving requests (e.g., from client devices) over a network, and carrying out those requests, or causing those requests to be carried out. The hardware may be one physical computer or one physical computer system, but neither is required to be the case with respect to the present technology. In the present context, the use of the expression a “server” is not intended to mean that every task (e.g., received instructions or requests) or any particular task will have been received, carried out, or caused to be carried out, by the same server (i.e., the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expression “at least one server”.

In the context of the present specification, “client device” is any computer hardware that is capable of running software appropriate to the relevant task at hand. Thus, some (non-limiting) examples of client devices include personal computers (desktops, laptops, netbooks, etc.), smartphones, and tablets, as well as network equipment such as routers, switches, and gateways. It should be noted that a device acting as a client device in the present context is not precluded from acting as a server to other client devices. The use of the expression “a client device” does not preclude multiple client devices being used in receiving/sending, carrying out or causing to be carried out any task or request, or the consequences of any task or request, or steps of any method described herein.

In the context of the present specification, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers.

In the context of the present specification, the expression “information” includes information of any nature or kind whatsoever capable of being stored in a database. Thus information includes, but is not limited to audiovisual works (images, movies, sound records, presentations etc.), data (location data, numerical data, etc.), text (opinions, comments, questions, messages, etc.), documents, spreadsheets, lists of words, etc.

In the context of the present specification, the expression “component” is meant to include software (appropriate to a particular hardware context) that is both necessary and sufficient to achieve the specific function(s) being referenced.

In the context of the present specification, the expression “computer usable information storage medium” is intended to include media of any nature and kind whatsoever, including RAM, ROM, disks (CD-ROMs, DVDs, floppy disks, hard drivers, etc.), USB keys, solid state-drives, tape drives, etc.

In the context of the present specification, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first server” and “third server” is not intended to imply any particular order, type, chronology, hierarchy or ranking (for example) of/between the server, nor is their use (by itself) intended imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 depicts a system suitable for implementing non-limiting embodiments of the present technology.

FIG. 2 depicts a processing pipeline performed by a server of FIG. 1 for generating modified audio based on original audio from a video file, in accordance with at least some embodiments of the present technology.

FIG. 3 is a schematic representation of an architecture of a Speaker Change Detection (SCD) model employed by the server of FIG. 1.

FIG. 4 depicts a first training iteration performed during punctuation training of the SCD model of FIG. 3, and a second training iteration performing during fine-tunning training of the SCD model of FIG. 3, by the server of FIG. 1.

FIG. 5 depicts an in-use training iteration performed during an in-use phase of the SCD model of FIG. 3 by the server of FIG. 1.

FIG. 6 is a scheme-block illustration of a method executable by the server of FIG. 1, in at least some embodiments of the present technology.

### DETAILED DESCRIPTION

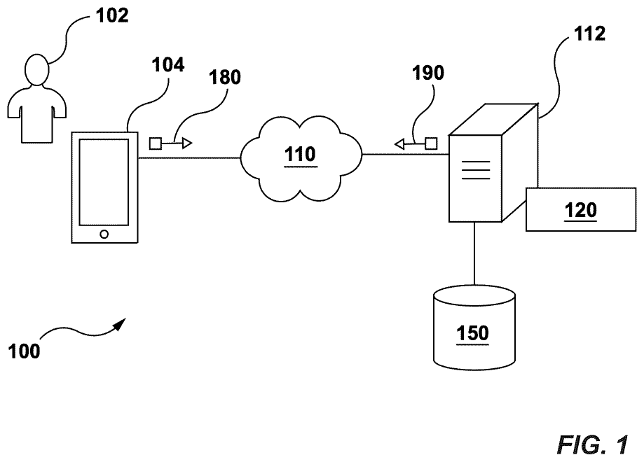

Referring to FIG. 1, there is shown a schematic diagram of a system 100, the system 100 being suitable for implementing non-limiting embodiments of the present technology. It is to be expressly understood that the system 100 as depicted is merely an illustrative implementation of the present technology. Thus, the description thereof that follows is intended to be only a description of illustrative examples of the present technology. This description is not intended to define the scope or set forth the bounds of the present technology. In some cases, what are believed to be helpful examples of modifications to the system 100 may also be set forth below. This is done merely as an aid to understanding, and, again, not to define the scope or set forth the bounds of the present technology. These modifications are not an exhaustive list, and, as a person skilled in the art would understand, other modifications are likely possible. Further, where this has not been done (i.e., where no examples of modifications have been set forth), it should not be interpreted that no modifications are possible and/or that what is described is the sole manner of implementing that element of the present technology. As a person skilled in the art would understand, this is likely not the case. In addition, it is to be understood that the system 100 may provide in certain instances simple implementations of the present technology, and that where such is the case they have been presented in this manner as an aid to understanding. As persons skilled in the art would understand, various implementations of the present technology may be of a greater complexity.

Generally speaking, the system 100 is configured to provide electronic dubbing services for a user 102 of an electronic device 104. For example, the system 100 may be configured to acquire a video file with an audio in a first language, generate an audio in a second language, and provide to the user the video file with the second language. At least some components of the system 100 will now be described, however, it should be understood that other components to those depicted in FIG. 1 may be part of the system 100 without departing from the scope of the present technology.

### Communication Network

The electronic device 104 is communicatively coupled to a communication network 110 for communication with the server 112. For example, the electronic device 104 may be communicatively coupled with the server 112 via the communication network 110 for providing the user 102 with online services, such as video streaming engines, for example. The communication network 110 is configured to transmit inter alia data between the electronic device 104 and the server 112 in a form of one or more data packets.

In some non-limiting embodiments of the present technology, the communication network 110 can be implemented as the Internet. In other non-limiting embodiments of the present technology, the communication network 110 can be implemented differently, such as any wide-area communication network, local-area communication network, a private communication network and the like. How a communication link (not separately numbered) between the electronic device 104 and the communication network 110 is implemented will depend inter alia on how the electronic device 104 is implemented.

Merely as an example and not as a limitation, in those embodiments of the present technology where the electronic device 104 is implemented as a wireless communication device (such as a smartphone), the communication link can be implemented as a wireless communication link (such as but not limited to, a 3G communication network link, a 4G communication network link, Wireless Fidelity, or Wi-Fi® for short, Bluetooth® and the like). In those examples where the electronic device 104 is implemented as a notebook computer, the communication link can be either wireless (such as Wireless Fidelity, or Wi-Fi® for short, Bluetooth® or the like) or wired (such as an Ethernet based connection).

### Electronic Device

The system 100 comprises the electronic device 104, the electronic device 104 being associated with the user 102. As such, the electronic device 104 can sometimes be referred to as a “client device”, “end user device”, “client electronic device” or simply “device”. It should be noted that the fact that the electronic device 104 is associated with the user 102 does not need to suggest or imply any mode of operation—such as a need to log in, a need to be registered, or the like.

The implementation of the electronic device 104 is not particularly limited, but as an example, the electronic device 104 may be implemented as a personal computer (desktops, laptops, netbooks, etc.), a wireless communication device (such as a smartphone, a cell phone, a tablet and the like), as well as network equipment (such as routers, switches, and gateways). The electronic device 104 comprises hardware and/or software and/or firmware (or a combination thereof), as is known in the art, to execute a browser application.

Generally speaking, the purpose of the browser application is to enable the user 102 to access one or more network resources, such as web pages, for example. How the browser application is implemented is not particularly limited. One example of the browser application may be embodied as a Yandex™ browser.

The user 102 may use the browser application for accessing a video streaming platform for streaming video content. For example, the electronic device 104 may be configured to generate a request indicative of video content that the user 102 desires to view. In some embodiments, the request from the electronic device 104 may further be indicative of a desired language for the audio accompanying the video content. Also, the electronic device 104 may be configured to receive a response (not depicted) for reproducing the video content and the audio in a selected language to the user 102. Typically, the request and the response may be transmitted from and to the electronic device 104 via the communication network 110. The content of the request and the response may depend on inter alia whether the video and audio content are live streamed or not.

### Database

The system 100 also comprises a database 150 which is communicatively coupled to the server 112 and is configured to store information extracted or otherwise determined or generated by the server 112. Generally speaking, the database 150 may receive data from the server 112 which was extracted or otherwise determined or generated by the server 112 during processing for temporary and/or permanent storage thereof and may provide stored data to the server 112 for use thereof. It is contemplated that the database 150 may be split into several distributed databases without departing from the scope of the present technology.

The database 150 may be configured to store data for supporting video streaming engines of the server 112. To that end, the database 150 may store inter alia a plurality of digital content items including video and audio files representative of media content consumable by the user 102. Examples of digital content items can include, but are not limited to, digital video, digital movies, digital audio, digital music, website content, social media content, and the like.

As it will become apparent from the description herein further below, the database 150 may be configured to store data for training, and fine-tuning, one or more machine learning models for generating sequences of output tokens including text tokens, punctuation tokens, and speaker change tokens.

### Server

The system 100 also comprises the server 112 that can be implemented as a conventional computer server. In the depicted non-limiting embodiments of the present technology, the server 112 is a single server. In alternative non-limiting embodiments of the present technology, functionalities of the server 112 may be distributed and may be implemented via multiple servers. The server 112 may include one or more processors, one or more non-transitory memory devices, computer-readable instructions, and/or additional hardware components, additional software components, and/or combination thereof, for implementing various functionalities of the server 112, without departing from the scope of the present technology.

Generally speaking, the server 112 can be under control and/or management of a video service provider (not depicted), such as, for example, an operator of Yandex™ video streaming platform. It is contemplated that the provider of the video streaming services, and the provider of the browser application may be the same provider. For example, the browser application (e.g., Yandex™ browser) and the video streaming engines (e.g., Yandex™ video streaming engines) may be provided, controlled and/or managed by the same operator or entity.

As mentioned above, the server 112 hosts a video streaming engine (not depicted). Broadly speaking, the video streaming engine is embodied as a plurality of computer-implemented procedures that are used for providing video content to the user 102 accompanied by audio content in one or more languages.

Developers of the present technology have realized that a large amount of the media content broadcasted online, for example, is originally produced in English while many users do not speak English or their command of English language may not be sufficiently good to enjoy the content in English. In order to make such media content accessible to a large variety of users, conventional solutions provide either subtitles in different languages, or dubbing audio content in different languages. Developers have devised a methods and systems that are configured to provide video dubbing services where audio content in one or more languages is generated by the server 112, without necessitating human intervention for generate audio content in the one or more languages.

In some embodiments, the server 112 is configured to provide automatic dubbing electronic services where original audio content is translated into one or more languages, and is reproduced in a male or female voice, and which can be superimposed onto the original video content for consumption by the user 102.

As it will be described in greater details herein further below, the automatic dubbing services may be implemented using several neural networks which can be configured to: (i) recognize speech (convert audio into text), split the recognized text into separate segments (e.g., sentences), translate segments into the target language, and generate the dubbing content that is overlayed over the original video content. The system can additionally determine the gender of the speaker and synthesize the appropriate voice characteristics.

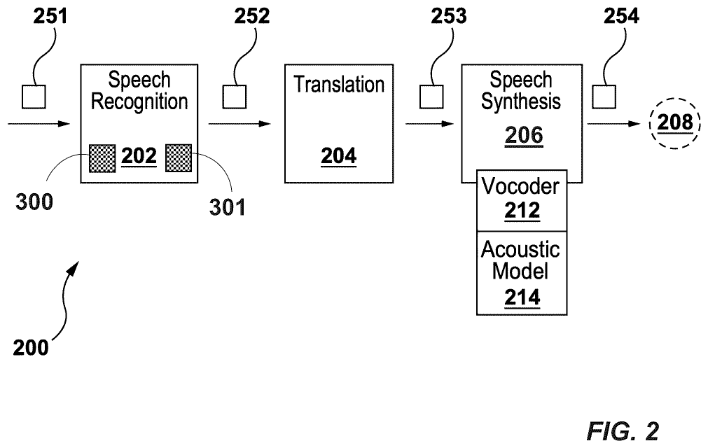

With reference to FIG. 2 there is depicted a processing pipeline 200 executed by the server 112 in some embodiments of the present technology. A first procedure of the processing pipeline 200 is performed by a speech recognition module 202 on an original audio content. Broadly, the first procedure is used to receive original audio content 251 and produce a speech recognition data 252.

The speech recognition data 252 may represent automatically recognized speech or other audio from a video content item. The speech recognition data 252 may include a plurality of generated character strings, where each individual generated character string represents a word, phrase, or set of characters spoken by speaker(s) within the video content item. Each generated character string within the speech recognition data 252 may by associated with timing information that represents the specific time at which the generated character string was spoken within the video. For example, the timing information for the phrase “Good morning” may include timing for when the word “Good” is spoken and timing for when the word “morning” is spoken. The timing information may include specific start and end times (e.g., timestamps) for each generated character string or may include a specific start time and duration information for each generated character string.

In some embodiments, the speech recognition module 202 may be configured to further process original audio content to remove artifacts that are not related to speech such as music sounds, for example. In further embodiments, the speech recognition module 202 may be configured to insert punctuation marks and/or may further divides words into sub-word segments.

In some embodiments, the speech recognition module 202 may comprise a Speech-To-Text (STT) model. The STT model may be a machine-learning model such as a Neural Network (NN) model. Non-limiting examples of NN models that can be used for implementation of the present technology may include a Recurrent NN model and/or a Long short-term memory NN model. In additional embodiments, the machine-learning model may be implemented as a transformer model.

In at least some embodiments, there is provided an Automatic Speech Recognition (ASR) model. The ASR may be implemented as a combination of a seq2seq model and a Convolutional Neural Network (CNN). The seq2seq model may be implemented as a VGG-Transformer model. Additionally or optionally, a CTC transformer may also be used for intermediate recognitions (e.g., partials). In at least some embodiments, the ASR model may be implemented similarly to an ASR model disclosed in a co-owned U.S. Pat. No. 11,145,305, the contents of which is incorporated herein by reference in its entirety.

As it will be described in greater details herein further below, the speech recognition module 202 may be configured to perform Speaker Change Detection (SCD). SCD is a technology-driven process that involves identifying and marking transitions between different speakers or actors in an audio and/or video recording. By recognizing when one character's dialogue ends and another's begins, the speech recognition module 202 may provide additional information to other components of the processing pipeline 200 for improving the process of generating dubbing content.

A second procedure of the processing pipeline 200 includes identifying, in the speech recognition data 252, phrases that have been uttered by respective speakers in the original audio content 251. In other words, the second procedure can include determining which speaker has produced a respective portion of the speech recognition data 252. According to certain non-limiting embodiments of the present technology, the second procedure can be executed by a diarization model 301. Broadly speaking, the diarization model 301 is configured to identify if two consecutive phrases in the speech recognition data 252 are produced by a same speaker or by different speakers. To do so, the diarization model 301 is configured to consider speaker change tokens generated by the speech recognition module 202.

More specifically, if the diarization model 301 receives two sentences and a speaker change token, which indicates a probability value of speaker change being 0, the diarization model 301 can determine that both sentences have been produced by the same speaker. By contrast, if the probability value indicated by the speaker change token between two given sentences is higher than a predetermined probability threshold (such as 0.75, 0.85, or 0.95), the diarization model 301 can be configured to determine that each of the two sentences have been produced by a different speaker.

In various non-limiting embodiments of the present technology, the diarization model 301 can be implemented as a NN with an Emphasized Channel Attention, Propagation and Aggregation in Time Delay Neural Network (ECAPA-TDNN) architecture. In a specific non-limiting example, the diarization model 301 can be implemented as described in a web resource huggingface.co/speechbrain/spkrec-ecapa-voxceleb. In order for the diarization model 301 to consider the speaker change tokens, a clustering algorithm can further be applied to an output of the diarization model 301.

In some non-limiting embodiments of the present technology, after applying the diarization model 301 and prior to translating the speech recognition data 252, the server 112 can be configured to concatenate phrases that have been spoken, in the original audio content 251, by a given speaker, thereby grouping the phrases in the speech recognition data 252 by respective speakers.

After applying the diarization model 301 and grouping the phrases in the speech recognition data 252 by the respective speakers, a third procedure of the processing pipeline 200 is performed by a translation module 204 on the speech recognition data 252. Broadly, the third procedure is used to receive the speech recognition data 252 and produce a translation data 253.

The translation data 253 represents a translation of character strings from the speech recognition data 252 (which is in an original language of the original audio content) in a second language. The translation module 204 may also receive information about the gender associated with a person speaking in the original audio content. In some cases, the translation module 204 may generate different translation data 253 depending on inter alia whether the speaking is male or female.

It is contemplated that the translation module 204 may be configured to execute a plurality of translation models for translation character strings from the original language into one or more second languages.

How a given translation model of the translation module 204 is implemented is not particularly limiting. In one embodiment, a translation model may be implemented as a Statistical Machine Translation (SMT) model trained to translate sentences from a first language to a second language.

Broadly, SMT deals with automatically mapping sentences in one human language (for example, French) into another human language (such as English). The first language is called the source and the second language is called the target. This process can be thought of as a stochastic process. There are many SMT variants, depending upon how translation is modeled. Some approaches are in terms of a string-to-string mapping, some use trees-to-strings, and some use tree-to-tree models. A SMT model is estimated from parallel corpora (source-target pairs) and/or from monolingual corpora (examples of target sentences). It is contemplated that the server 112 may be configured to generate a given translation function by training an SMT model based on aligned corpuses of text between a respective pair of languages. It is contemplated that a given translation model may be implemented as an encoder-decoder type model, without departing from the scope of the present technology.

In some embodiments, the translation model may be embodied as a NN with a transformer architecture. The transformer architectures' ability to consider broad context introduced with Long Short-Term Memory (LSTM) networks and later, by the attention mechanism, may be beneficial for use as the translation model. It is contemplated that the translation model may be provided with additional feature, such as a gender of the speaker, for example.

A fourth procedure of the processing pipeline 200 is performed by a speech synthesis module 206 on the translation data 253. Broadly, the fourth procedure is used to receive the translation data 253 and produce the speech synthesis data 254.

The speech synthesis data 254 comprises translated audio content generated based on inter alia the translation data 253 and where the translated audio content is representative of sentences spoken in one (or more) other languages. Further, based on the speech synthesis data 254, the server 112 can be configured to generate an output audio content 208 including voiced translated character strings of the translation data 253. Further, the server 112 can be configured to cause playing back the output audio content 208 on the electronic device 104 for presentation to the user 102.

According to certain non-limiting embodiments of the present technology, The speech synthesis module 206 may comprise an acoustic model 214 and a vocoder 212. According to certain non-limiting embodiments of the present technology, the acoustic model 214 and the vocoder 21 can be implemented as deep neural models. It should be noted that the acoustic model 214 can generate mel-spectrograms based on phonemes, for example, and the vocoder 212 can synthesize time-domain waveforms, and which can be conditioned on mel-spectrograms from a text-to-spectrogram model.

In some embodiments of the present technology, the acoustic model may be embodied as a known Tacotron 2 model. Broadly, Tacotron 2 is a recurrent sequence-to-sequence feature prediction network with attention mechanism(s) that predicts a sequence of mel spectrogram frames from an input character sequence. In other embodiments, the vocoder may be embodied as a known HiFi-GAN model. Broadly, the HiFi-GAN architecture may comprise one generator and two discriminators: multi-scale and multi-period discriminators. The generator is a fully convolutional neural network. It uses a mel-spectrogram as input and up samples it through transposed convolutions until a length of the output sequence matches the temporal resolution of raw waveforms. Every transposed convolution is followed by a multi-receptive field fusion (MRF) module. In other embodiments, the vocoder may be embodied similarly to a model described in a co-owned US patent application US2022/084499, entitled “Method and server for a text-to-speech processing”, published on Mar. 17, 2022, the contents of which is incorporated herein by reference in its entirety.

In some embodiments of the present technology, the speech synthesis module 206 may be implemented in a similar manner to how a speech synthesis module is implemented in a co-owned Russian application number 2022134630, filed on Dec. 27, 2022, the contents of which is incorporated herein by reference in its entirety.

In some embodiments, the speech synthesis module 206 may also receive information about the gender associated with a person speaking in the original audio content. In some cases, the speech synthesis module 206 may generate different speech synthesis data 254 depending on inter alia whether the speaking is male or female.

As it can be appreciated, the speech synthesis module 206 may also receive information about change in speakers between different portions of the original audio content 251 that has been generated by the diarization model 301 prior to translating the speech recognition data 252. Thus, in some cases, the translation module 204 may generate respective portions of the speech synthesis data 254 depending on inter alia whether a first given speaker is associated with a given speech or a second different speaker is associated with the given speech.

### SCD Model

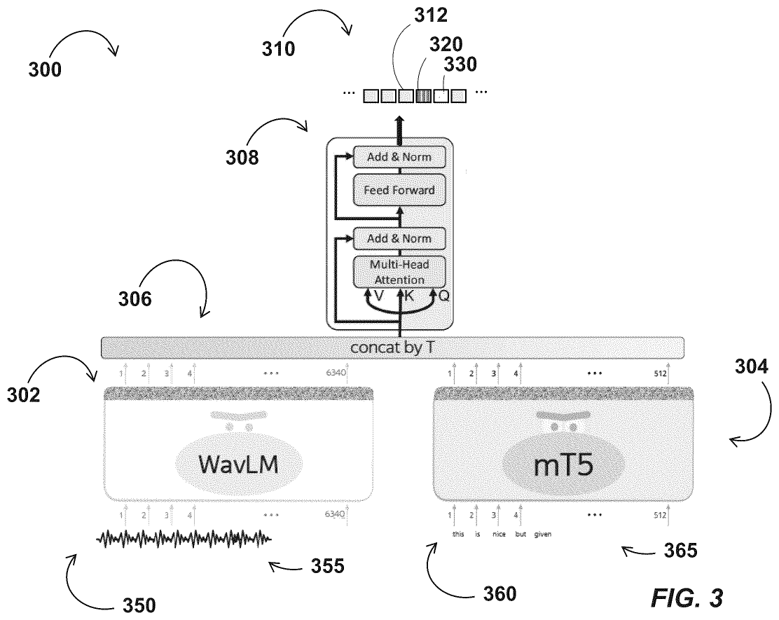

With reference to FIG. 3, there is depicted a non-limiting example of a SCD model 300 that is used by the server 112 as part of the speech recognition module 202 in at least one embodiment of the present technology.

Broadly speaking, the SCD model 300 is configured to acquire audio data 350 and corresponding textual data 360 as input, and in response, generate an output in a form of a sequence of tokens 310 comprising information indicative of a change of speakers within content of the audio data 350 and the corresponding textual data 360.

The SCD model 300 comprises an audio-dedicated sub-model 302 and a text-dedicated sub-model 304 which are provided with the audio data 350 and the corresponding textual data 360, respectively. More specifically, the server 112 may be configured to split the audio data 350 into a sequence of audio data segments 355 and provide the sequence of the audio data segments 355 as respective inputs to the audio-dedicated sub-model 302. Also, the server 112 may be configured to split the textual data 360 into a sequence of textual data segments 365 and provide the sequence of the textual data segments 365 as respective inputs to the text-dedicated sub-model 304.

In the embodiment illustrated in FIG. 3, the server 112 is configured to generate the sequence 355 including 6,340 respective audio data segments and the sequence 365 including 512 respective textual data segments. It is contemplated that a total number of segments in the sequence 355 and in the sequence 365 may depend on inter alia a specific implementation of the audio-dedicated sub-model 302, a specific implementation of the text-dedicated sub-model 304, data size of the audio data 350, and/or data size of textual data 360.

In this embodiment, the architecture of the audio-dedicated sub-model 302 may be implemented similarly to the architecture of a WavLM model disclosed in an article entitled “WavLM: Large-Scale Self-Supervised Pre-Training for Full Stack Speech Processing”, authored by Sanyuan Chen et al., published in June 2022, and the contents of which is incorporated herein by reference in its entirety. The WavLM model architecture uses a transformer model as a backbone and contains a convolutional feature encoder and a transformer encoder. The convolutional encoder is composed of seven blocks of temporal convolution followed by layer normalization and a GELU activation layer. In one implementation, the temporal convolutions have 512 channels with strides (5,2,2,2,2,2,2) and kernel widths (10,3,3,3,3,2,2), resulting in each output representing about 25 ms of audio strode by 20 ms. The convolutional output representation is masked as the transformer input. The transformer is equipped with a convolution-based relative position embedding layer with 128 kernel size and 16 groups at the bottom. To improve the model, a gated relative position bias may be employed which is encoded based on the offset between the “key” and “query” in the transformer self-attention mechanism.

In this embodiment, the architecture of the text-dedicated sub-model 304 may be implemented similarly to the architecture of a mT5 model disclosed in an article entitled “mT5: A Massively Multilingual Pre-trained Text-to-Text Transformer”, authored by Linting Xue et al., published in March 2021, and the contents of which is incorporated herein by reference in its entirety.

The SCD model 300 is configured to concatenate output embeddings of the audio-dedicated sub-model 302 with output embeddings of the text-dedicated sub-model 304, thereby generating a concatenated intermediate output 306 of the SCD model 300. It can be said that the SCD model 300 is configured to process simultaneously the audio data 350 and the textual data 360 and generate the concatenated intermediate output 306 based on both (i) audio-based embeddings and (ii) text-based embeddings.

In the embodiment illustrated in FIG. 3, the server 112 is configured to generate the concatenated intermediate output 306 by concatenating 6,340 audio-based embeddings with 512 text-based embeddings. It is contemplated that a total number audio-based and text-based embeddings to be concatenated may depend on inter alia a specific implementation of the audio-dedicated sub-model 302, a specific implementation of the text-dedicated sub-model 304, data size of the audio data 350, and/or data size of textual data 360.

The concatenated intermediate output 306 is then provided to a third sub-model 308 configured to process the concatenated intermediate output 306 and generate in response the sequence of tokens 310. In this embodiment, the architecture of the third sub-model 308 is implemented similarly to the architecture of a transformer sub-model. For example, the third sub-model 308 may be implemented as a transformer model configured to receive concatenated audio-based and text-based embeddings (e.g., the concatenated intermediate output 306) and generate a sequence of tokens (e.g., the sequence of tokens 310).

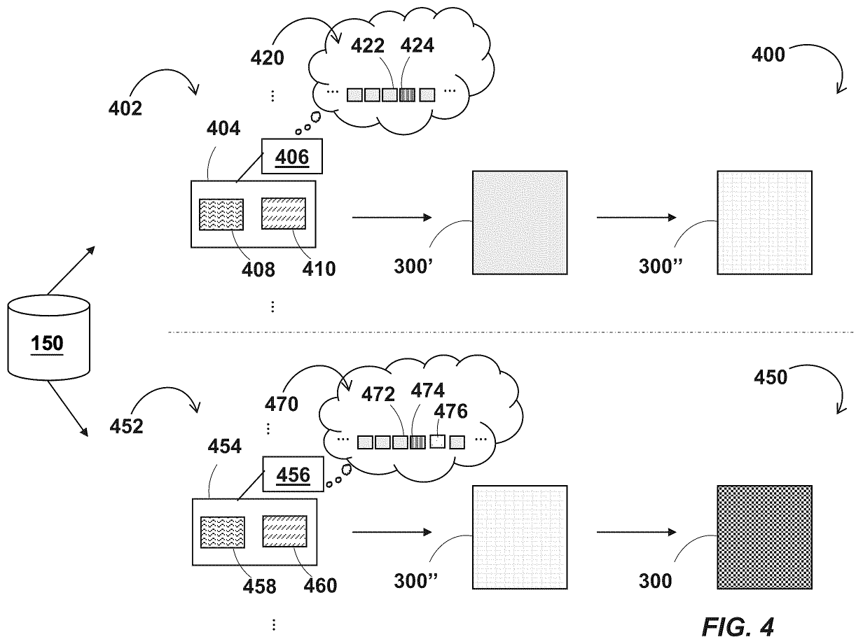

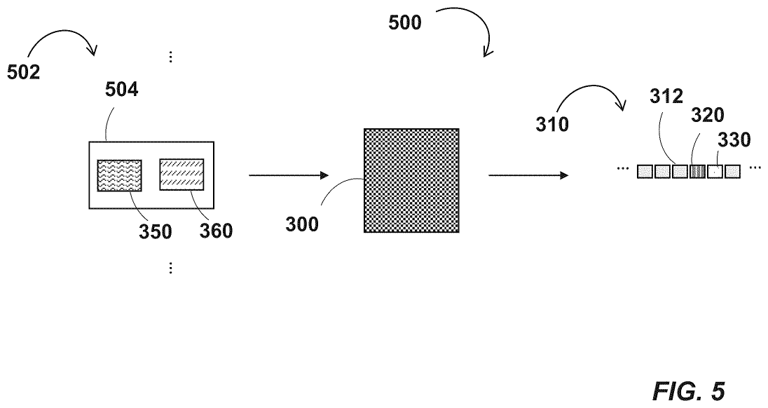

In the context of the present technology, the SCD model 300 is configured to generate the sequence of tokens 310 comprising at least three types of tokens, namely (i) word tokens, (ii) punctuation tokens, and (iii) speaker change tokens. In the example illustrate in FIG. 3, the sequence of tokens 310 comprises a word token 312, a punctuation token 320, and a speaker change token 330. It should be noted that a sub-sequence of tokens including the word token 312, the punctuation token 320, and the speaker change token 330 may be indicative of that a first speaker uttered a given word associated with the word token 312, the given word is a last word in a sentence as the punctuation token 312 may be representative of a period, and a second different speaker utters a next word in the recording. How the server 112 is configured to training and use the SCD model 300 is for generating punctuation tokens and speaker change tokens as part of the sequence of tokens 310 will now be described with reference to FIGS. 4 and 5, respectively.

### Training

In some embodiments of the present technology, the server 112 may be configured to perform at least two training phases of the SCD model 300. During a first phase, the server 112 is configured to train a machine learning algorithm based on a large amount of data. Then, during a second phase, the server 112 is configured to “fine-tune” the now pre-trained machine learning algorithm based on supplementary data for adjusting the algorithm to a particular task. Broadly, training the machine learning algorithm during the first phase involves teaching the machine learning algorithm patterns from data whereas as fine-tuning is a subsequent phase for optimizing performance. Fine tunning may be employed for correcting overfitting, adapting the model to new tasks, and/or adjusting parameters of the model for better results. It's an iterative process that may be employed by the server 112 for enhancing the model's accuracy and effectiveness.

More particularly, the initial training is used to build a machine learning model. The initial training phase may begin with collection and preparation of a main dataset that contains input data (features) and the corresponding target outputs. The model is then trained by the server 112 learns patterns, relationships, and statistical representations from this dataset to make predictions or classifications.

During the initial training phase, the server 112 may be configured to divide the initial dataset into a training set and a validation set. The server 112 may also select a model architecture for the model and initialise its hyperparameters (e.g., learning rate, batch size, etc.). The selected model architecture is then fed the training dataset, and in response the internal parameters of the model architecture are iteratively adjusted to minimize the difference between its predictions and the target values (labels). The server 112 may then be configured to compute one or more performance metrics to evaluate the model's performance on the validation dataset.

During the fine-tunning phase, the now pre-trained model is adapted to a specific task or condition. If the pre-trained model performs well on the training data but poorly on unseen data (overfitting), the fine-tuning phase may involve regularization techniques and/or hyperparameter adjustment to improve generalization.

In at least those cases where pre-trained model(s) is/are available, fine-tuning can involve using a pre-trained model as a starting point and training it on a new, related task. For example, the server 112 may be configured to retrieve from the database 150 a pre-trained model and execute a fine-tuning phase thereon to adjust the pre-trained model for solving a new, related task. Developers of the present technology have appreciated that employing transfer learning concepts onto a pre-trained model, as opposed to performing the initial training phase on the model may save on time and computational resources.

With reference to FIG. 4, there is depicted a first training iteration 400 that the server 112 may perform during an initial training phase of a model 300″, and a second training iteration 450 that the server 112 may perform during a fine-tuning phase of a pre-trained model 300′. The first training iteration 400 and the second training iteration 450 will now be described in turn.

### Punctuation Training

During the first training iteration 400, the server 112 may acquire a first training dataset 402 comprising training input 404 and a label 406. The training input 404 includes an audio input 408 and a textual input 410. The audio input 408 is a recording of speaker utterance, and the textual input 408 is a corresponding text representing the speaker utterance. It should be noted that the corresponding text represents words uttered by the speaker, without any punctuations. The label 406 includes a target sequence of tokens 420 including word tokens representing words uttered by the speaker and punctuation tokens representing ground-truth positions of punctuations amongst the words. In one embodiment, positions of the punctuation tokens may be indicated by human assessors for the corresponding text. In another embodiment, the corresponding text may be originally provided with punctuations, but which are then removed for the purpose of generating training data. For example, the target sequence of tokens 420 include a word token 422 followed by a punctuation token 424 which may be indicative that the word token 422 is a last word in a given sentence uttered by the speaker.

The server 112 is configured to feed the training input 404 to the model 300″ (e.g., the audio input 408 may be provided to an audio-dedicated sub-model, and the textual input 410 may be provided to a text-dedicated sub-model). The model 300″ may be configured to generate a predicted sequence of tokens that is compared to the target sequence of tokens 420 from the label 406. The model 300″ is then adjusted based on the comparison between the predicted sequence of tokens and the target sequence of tokens 420. After a large number of training iterations performed similarly to the first training iteration 400, the server 112 is configured to perform initial training of the model 300″, and thereby generate a trained model 300′. The trained model 300′ has been trained to predict positions of punctuation tokens within output sequence of tokens to determine where in the text version of the speaker utterance punctuations should be inserted for augmenting the text version of the speaker utterance. It should be noted that so-augmented text version of the speaker utterance may be beneficial for increasing performance of one or more components of the dubbing system.

Developers of the present technology have appreciated that large datasets are available for punctuation training. Punctuation training datasets may comprise video and/or audio files with associated subtitles. In some embodiments, the server 112 may be configured to perform one or more filtering operations when generating the punctuation training dataset. It is contemplated that the server 112 may be configured to acquire the punctuation training dataset from the database 150. In one implementation the punctuation training dataset may include about one million hours of audio data with corresponding punctuated textual data (ground-truth). During the punctuation training, it can be said that a model is trained to predict punctuation indicators after respective words.

### Speaker Change Fine-Tuning

During the second training iteration 450, the server 112 may acquire a second training dataset 452 comprising training input 454 and a label 456. The training input 454 includes an audio input 458 and a textual input 460. The audio input 458 is a recording of speaker(s) utterance(s), and the textual input 458 is a corresponding text representing the speaker(s) utterance(s). It should be noted that the corresponding text represents words uttered by one or more speakers, without any punctuations. The label 456 includes a target sequence of tokens 470 including word tokens representing words uttered by the one or more speakers, punctuation tokens representing ground-truth positions of punctuations amongst the words, and speaker change tokens representing ground-truth indications where a given speaker stopped uttering words and an other different speaker begins uttering words. For example, the target sequence of tokens 470 includes a word token 472 followed by a punctuation token 474 which may be indicative that the word token 422 is a last word in a given sentence uttered by the given speaker, and followed by a speaker change token 476 which may be indicative of that the word token 422 is the last word in a given sentence uttered by the given speaker before a different speaker begins uttering the next sentence.

The server 112 is configured to feed the training input 454 to the now pre-trained model 300′ (e.g., the audio input 458 may be provided to an audio-dedicated sub-model, and the textual input 460 may be provided to a text-dedicated sub-model). The pre-trained model 300′ may be configured to generate a predicted sequence of tokens that is compared to the target sequence of tokens 470 from the label 456. The pre-trained model 300′ is then adjusted based on the comparison between the predicted sequence of tokens and the target sequence of tokens 470. After a large number of training iterations performed similarly to the first training iteration 400, the server 112 is configured to perform fine-tuning training of the pre-trained model 300′, and thereby generate the SCD model 300. The SCD model 300 has been trained to predict positions of punctuation tokens within output sequence of tokens to determine where in the text version of the speaker utterance punctuations should be inserted for augmenting the text version of the speaker utterance, and to predict positions of speaker change tokens in the output sequence of tokens to determine where in the text version of the speaker utterance a change in speakers occurred for further augmenting the text version of the speaker utterance. It should be noted that so-augmented text version of the speaker utterance may be beneficial for increasing performance of one or more components of the dubbing system.

Developers of the present technology have appreciated that large datasets are more scarce for speaker change training than for punctuation training. Speaker change training datasets may also comprise video and/or audio files with associated subtitles. In some embodiments, the server 112 may be configured to perform one or more filtering operations when generating the speaker change training dataset. It is contemplated that the server 112 may be configured to acquire the speaker change training dataset from the database 150. In one implementation the speaker change training dataset may include about one hundred hours of audio data with corresponding punctuated textual data (ground-truth). During the speaker change training, it can be said that a model is trained to predict punctuation indicators as well as speaker change indicators after respective words.

Without wishing to be bound to any specific theory, developers have realized that performing fine-tuning training on a model having been pre-trained for a punctuation detection task, allows the model to use punctuation tokens as “hints” for the speaker change detection task. In other words, the SCD model 300 in a sense “understands” that a change in speakers is unlikely to occur in within a given sentence (i.e., after a word token) and/or in a sense “understands” that if a change in speakers is comparatively more likely to occur after a given sentence ends (i.e., after a punctuation token indicative of a period). It can also be said that the SCD model 300 is trained to “understand” that a probability of a next token (to be generated) being a speaker change token is comparatively higher when a latest token (having been generated) is a punctuation token than when the latest token is a word token.

### In-Use

With reference to FIG. 5, there is depicted an in-use iteration 500 of the SCD model 300 executable by the server 112 for generating the sequence of tokens 310. The server 112 is configured to acquire an in-use dataset 502. The in-use dataset 502 comprises the audio data 350 and the corresponding textual data 360. In some embodiments, the in-use dataset 502 may include pre-recorded data acquired from the database 150. In other embodiments, the in-use dataset 502 may be a real-time dataset acquired by the server 112, such as part of a live broadcasts and/or video conferencing where immediate dubbing is required, for example. In further embodiments, a video file may be acquired with the audio data 350 and the server 112 may be configured to extract the corresponding textual data 360 from the audio data 350 using known techniques.

As previously alluded to, the server 112 may be configured to split the audio data 350 into the sequence of audio data segments and provide them as inputs to the audio-dedicated sub-model 302 of the SCD model 300. Also, the server 112 may be configured to split the textual data 360 into the sequence of textual data segments and provide them as inputs to the text-dedicated sub-model 304 of the SCD model 300. In response, the SCD model 300 is configured to concatenate intermediate embeddings generated by the audio-dedicated sub-model 302 and the text-dedicated sub-model 304, and the intermediate concatenated output of the SCD model 300 is further processed by the output sub-model 308 for generating the sequence of output tokens 310 including the word token 312, followed by the punctuation token 320, and followed by the speaker change token 330.

Further, as alluded to above, in some non-limiting embodiments of the present technology, the server 112 can be configured to feed the sequence of output tokens 310 including the word token 312, followed by the punctuation token 320, and followed by the speaker change token 330 to the diarization model 301 for identifying, in the sequence of output tokens 310, phrases that have been uttered by different speakers. Further, based on the output of the diarization model 301, the server 112 can be configured to group the phrases of the speech recognition data 252 by respective speakers having uttered the phrases. Further, as described in detail above, the server 112 can be configured to: (i) translate the so grouped phrases using the translation module 204, thereby generating the translation data 253; and (ii) generate, using the speech synthesis module 206, for each translated phrase associated with a given speaker of the translation data 253, a respective portion of the speech synthesis data 254, as described above.

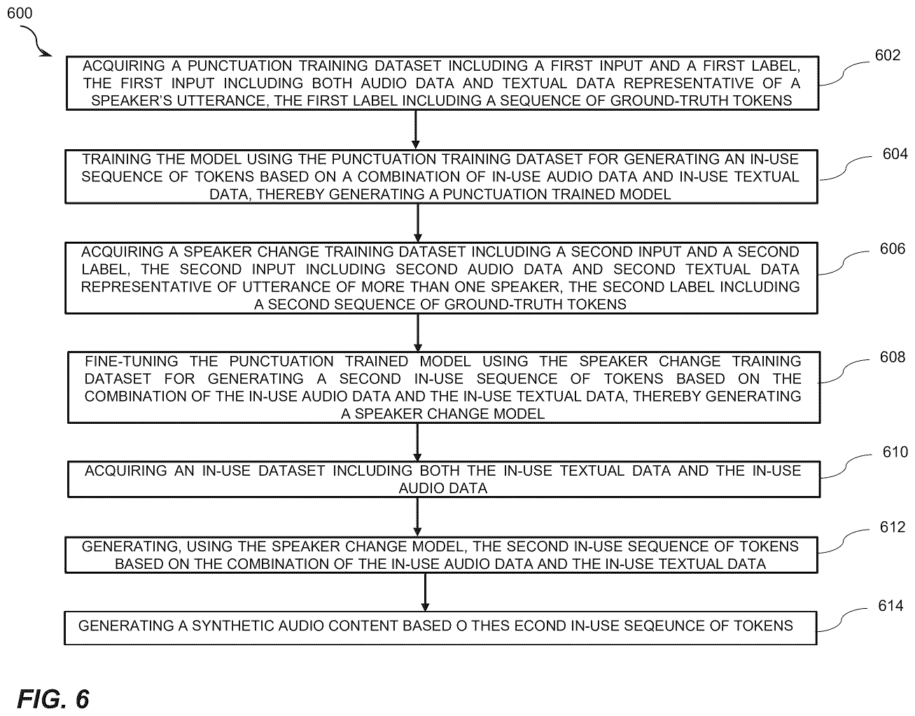

Given the architecture and examples provided hereinabove, it is now possible to implement a method of training a model, such as the SCD model 300. With reference now to FIG. 6, there is depicted a flowchart diagram of a method 600, in accordance with certain non-limiting embodiments of the present technology. The method 600 can be executable by the server 112.

As mentioned hereinabove, the server 112 can be configured to the server 112 to perform at least two training phases of the SCD model 300. During the first phase, which is described in detail above with reference to FIG. 4 with respect to the first training iteration 400, the server 112 is configured to train a given machine learning algorithm based on a large amount of data to generate, for a given sequence of text tokens, predicted punctuation tokens. Then, during the second phase, which is described in detail above with reference to FIG. 4 with respect to the second training iteration 450, the server 112 is configured to “fine-tune” the now pre-trained machine learning algorithm based on supplementary data for adjusting the algorithm to predict positions of speaker change tokens in the given sequence of text tokens.

Step 602: Acquiring a Punctuation Training Dataset Including A First Input and a First Label, the First Input Including Both Audio Data and Textual Data Representative of a Speaker'S Utterance, the First Label Including a Sequence of Ground-Truth Tokens

The method 600 commences at step 602 with the server 112 being configured to acquire the first training dataset 402 for training the model 300″ to determine positions of punctuation tokens in the given sequence of text tokens. As described in detail above with reference to FIG. 4, the first training dataset 402 comprises the training input 404 and the label 406. According to certain non-limiting embodiments of the present technology, the training input 404 includes the audio input 408 and the textual input 410. The audio input 408 is a recording of a speaker utterance, and the textual input 408 is a corresponding text representing the speaker utterance.

The label 406 includes the target sequence of tokens 420 including word tokens representing words uttered by the speaker and punctuation tokens representing ground-truth positions of punctuations amongst the words. In one embodiment, positions of the punctuation tokens may be indicated by human assessors for the corresponding text.

The method 600 hence advances to step 604.

Step 604: Training the Model Using the Punctuation Training Dataset for Generating an in-Use Sequence of Tokens Based on a Combination of in-Use Audio Data and in-Use Textual Data, Thereby Generating a Punctuation Trained Model

At step 604, according to certain non-limiting embodiments of the present technology, the server 112 is configured to feed the training input 404 to the model 300″ (e.g., the audio input 408 may be provided to an audio-dedicated sub-model, and the textual input 410 may be provided to a text-dedicated sub-model). In response, the model 300″ may be configured to generate the predicted sequence of tokens that is compared to the target sequence of tokens 420 from the label 406. Further, the server 112 can be configured to adjust the model 300″ by optimizing a difference between the predicted sequence of tokens and the target sequence of tokens 420 (which, for example, can be expressed by a loss function). After a large number of training iterations performed similarly to the training iteration 400, the server 112 is configured to perform initial training of the model 300″, and thereby generating the trained model 300′.

Thus, the trained model 300′ has been trained to predict positions of punctuation tokens within output sequence of tokens to determine where in the text version of the speaker utterance punctuations should be inserted for augmenting the text version of the speaker utterance. It should be noted that so-augmented text version of the speaker utterance may be beneficial for increasing performance of one or more components of the dubbing system.

The method 600 hence advances to step 606.

Step 606: Acquiring a Speaker Change Training Dataset Including a Second Input and a Second Label, the Second Input Including Second Audio Data and Second Textual Data Representative of Utterance of More than One Speaker, the Second Label Including a Second Sequence of Ground-Truth Tokens

At step 606, according to certain non-limiting embodiments of the present technology, the server 112 can be configured to acquire the second training dataset 452 for training the trained model 300′ to predict positions of speaker change tokens in the given sequence of text tokens. As described in detail hereinabove with reference to FIG. 4, the second training dataset 452 comprises the training input 454 and the label 456. According to certain non-limiting embodiments of the present technology, the training input 454 includes the audio input 458 and the textual input 460. The audio input 458 is a recording of speaker(s) utterance(s), and the textual input 458 is a corresponding text representing the speaker(s) utterance(s). It should be noted that the corresponding text represents words uttered by one or more speakers, without any punctuations. The label 456 includes the target sequence of tokens 470 including: (1) the word tokens representing words uttered by the one or more speakers, (2) the punctuation tokens representing ground-truth positions of punctuations amongst the words, and (3) the speaker change tokens representing ground-truth indications where a given speaker stopped uttering words and an other different speaker begins uttering words.

The method 600 hence advances to step 608.

Step 608: Fine-Tuning the Punctuation Trained Model Using the Speaker Change Training Dataset for Generating a Second in-Use Sequence of Tokens Based on the Combination of the in-Use Audio Data and the in-Use Textual Data, Thereby Generating a Speaker Change Model

At step 608, according to certain non-limiting embodiments of the present technology, the server 112 can be configured to fine-tune, using the second training dataset acquired at step 606, the trained model 300′ to determine positions of the speaker change tokens.

To that end, according to certain non-limiting embodiments of the present technology, the server 112 is configured to feed the training input 454 to the pre-trained model 300′ (e.g., the audio input 458 may be provided to the audio-dedicated sub-model 302, and the textual input 460 may be provided to the text-dedicated sub-model 304). In response, the pre-trained model 300′ may be configured to generate the predicted sequence of tokens, which the server 112 is configured to compare to the target sequence of tokens 470 from the label 456. Further, the server 113 can be configured to adjust the pre-trained model 300′ by minimizing a difference between the predicted sequence of tokens and the target sequence of tokens 470, which, for example, can be expressed by a respective value of the loss function.

Thus, after a large number of training iterations performed similarly to the training iteration 400, the server 112 is configured to perform fine-tuning training of the pre-trained model 300′, thereby generating the SCD model 300.

The SCD model 300 has now been trained to predict positions of punctuation tokens within output sequence of tokens to determine where in the text version of the speaker utterance punctuations should be inserted for augmenting the text version of the speaker utterance, and to predict positions of speaker change tokens in the output sequence of tokens to determine where in the text version of the speaker utterance a change in speakers occurred for further augmenting the text version of the speaker utterance. It should be noted that so-augmented text version of the speaker utterance may be beneficial for increasing performance of one or more components of the dubbing system.

The method 600 hence advances to step 610.

Step 610: Acquiring an in-Use Dataset Including Both the in-Use Textual Data and the in-Use Audio Data

At step 610, according to certain non-limiting embodiments of the present technology, the server 112 can be configured to acquire the in-use dataset 502. As described in detail above with reference to FIG. 5, the in-use dataset 502 comprises the audio data 350 and the corresponding textual data 360.

The method 600 hence advances to step 612.

Step 612: Generating, Using the Speaker Change Model, the Second In-Use Sequence of Tokens Based on the Combination of the in-Use Audio Data and the in-Use Textual Data

Further, the server 112 can be configured to apply the SCD model 300 to the in-use dataset 502. To that end, according to certain non-limiting embodiments of the present technology, the server 112 may be configured to split the audio data 350 into the sequence of audio data segments and provide them as inputs to the audio-dedicated sub-model 302 of the SCD model 300. Also, the server 112 may be configured to split the textual data 360 into the sequence of textual data segments and provide them as inputs to the text-dedicated sub-model 304 of the SCD model 300.

In response, the SCD model 300 is configured to concatenate intermediate embeddings generated by the audio-dedicated sub-model 302 and the text-dedicated sub-model 304, and the intermediate concatenated output of the SCD model 300 is further processed by the output sub-model 308 for generating the sequence of output tokens 310 including the word token 312, followed by the punctuation token 320, and followed by the speaker change token 330.

The method 600 hence advances to step 614.

Step 614: Identifying, Using a Diarization Model, in the Second in-Use Sequence of Tokens, in-Use Text Tokens Associated with Respective Speakers for Further Translation and Speech Synthesis

Further, after determining the positions of the punctuation and speaker changes tokens in the in-use dataset 502, the server 112 can be configured to identify, in the corresponding textual data 360 of the in-use data 502, which phrases have been uttered by which speakers. In other words, the server 112 can be configured to determine whether two consecutive phrases of the corresponding textual data 360 have been uttered by the same or different speakers. To that end, according to certain non-limiting embodiments of the present technology, the server 112 can be configured to apply, to the sequence of output tokens 310, the diarization model 301, as described above.

Further, in some non-limiting embodiments of the present technology, the server 112 can be configured to: (i) group (such as concatenate, for example) phrases that have been identified, by the diarization model 301, as associated with the given speaker; and (ii) and transmit the so grouped output tokens of the SCD model 300 to the translation module 204 for translation and further to the speech synthesis module 206 for generating respective portions of the speech synthesis data 254.

In some non-limiting embodiments of the present technology, the translation module 204 can be configured to generate a respective portion of the translation data 253 for each group of the sequence of output tokens 310 defined by the diarization module 301. Similarly, in some non-limiting embodiments of the present technology, the speech synthesis module 206 can be configured to generate each portion of the speech synthesis data 254 for a respective group of the sequence of output tokens 310 associated with the respective speaker identified by the diarization model 301, which can include, for example, generating a given portion of the speech synthesis data 254 in a specific respective voice corresponding to a voice of the respective speaker having uttered the original phrase in the the audio data 350 of the in-use data 502. In other words, after grouping tokens of the sequence of output tokens 310 by the diarization model 301, the server 112 can be configured to translate and synthesize the output tokens 310, using the translation and speech synthesis modules 204, 206, respectively, by groups.

Thus, in some non-limiting embodiments of the present technology, the translation and speech synthesis modules 204, 206 may not directly use the speaker change tokens generated by the SCD model 300, such as the speaker change token 330, but only use the phrases grouped by the respective speakers identified by the diarization model 301 using the speaker change tokens.

The method 600 hence terminates.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

1. A method of training a model, the method executable by a server, the method comprising:
acquiring a punctuation training dataset including a first input and a first label,
the first input including both audio data and textual data representative of a speaker's utterance, the first label including a sequence of ground-truth tokens,
the sequence of ground-truth tokens including (i) a ground-truth text token indicative of a word and (ii) a ground-truth punctuation token indicative of a punctuation, the ground-truth punctuation token positioned after the ground-truth text token;
training the model using the punctuation training dataset for generating an in-use sequence of tokens based on a combination of in-use audio data and in-use textual data, thereby generating a punctuation trained model;
acquiring a speaker change training dataset including a second input and a second label,
the second input including second audio data and second textual data representative of utterance of more than one speaker, the second label including a second sequence of ground-truth tokens,
the second sequence of ground-truth tokens including (i) a second ground-truth text token indicative of a second word,
(ii) a second ground-truth punctuation token indicative of a second punctuation, and (iii) a ground-truth speaker change token indicative of a change in speakers, the ground-truth speaker change token being positioned after the second ground-truth punctuation token;
fine-tuning the punctuation trained model using the speaker change training dataset for generating a second in-use sequence of tokens based on the combination of the in-use audio data and the in-use textual data, thereby generating a speaker change model;
acquiring an in-use dataset including both the in-use textual data and the in-use audio data;
generating, using the speaker change model, the second in-use sequence of tokens based on the combination of the in-use audio data and the in-use textual data,
the second in-use sequence of tokens including an in-use text token, an in-use punctuation token positioned after the in-use text token, and an in-use speaker change token positioned after the in-use punctuation token; and
generating a synthetic audio content based on the second in-use sequence of tokens.

2. The method of claim 1, wherein the speaker change model includes an audio sub-model, a text sub-model, and a third sub-model, the generating the second in-use sequence of tokens including:
generating, using the audio sub-model, an in-use sequence of audio embeddings based on the in-use audio data;
generating, using the text sub-model, an in-use sequence of text embeddings based on the in-use textual data;
generating a concatenated intermediate output using the in-use sequence of audio embeddings and the in-use sequence of text embeddings; and
generating, using the third sub-model, the second in-use sequence of tokens using the concatenated intermediate output.

3. The method of claim 2, wherein the audio sub-model is a WavLM model.

4. The method of claim 2, wherein the text sub-model is a mT5 model.

5. The method of claim 2, wherein the third sub-model is a transformer model.

6. The method of claim 1, wherein the method further comprises:
generating, using a speech-to-text model, the textual data based on the audio data;
generating, using the speech-to-text model, the second textual data based on the second audio data; and
generating, using a speech-to-text model, the in-use textual data based on the in-use audio data.

7. The method of claim 1, wherein:
the ground-truth punctuation token is positioned immediately after the ground-truth text token;
the ground-truth speaker change token is positioned immediately after the second ground-truth punctuation token;
the in-use punctuation token is positioned immediately after the in-use text token; and
the in-use speaker change token is positioned immediately after the in-use punctuation token.

8. A method of fine-tuning a pre-trained model, the method executable by a server, the method comprising:
acquiring a speaker change training dataset including a second input and a second label,
the second input including second audio data and second textual data representative of utterance of more than one speaker, the second label including a second sequence of ground-truth tokens,
the second sequence of ground-truth tokens including (i) a second ground-truth text token indicative of a second word, (ii) a second ground-truth punctuation token indicative of a second punctuation, and (iii) a ground-truth speaker change token indicative of a change in speakers, the ground-truth speaker change token being positioned after the second ground-truth punctuation token in the second sequence of ground-truth tokens;
fine-tuning the pre-trained model using the speaker change training dataset for generating a second in-use sequence of tokens based on a combination of an in-use audio data and an in-use textual data, thereby generating a speaker change model,
the pre-trained model having been trained based on a punctuation training dataset for generating an in-use sequence of tokens based on the combination of the in-use audio data and the in-use textual data, the punctuation training dataset including a first input and a first label, the first input including both audio data and textual data representative of a speaker's utterance, the first label including a sequence of ground-truth tokens, the sequence of ground-truth tokens including (i) a ground-truth text token indicative of a word and (ii) a ground-truth punctuation token indicative of a punctuation, the ground-truth punctuation token being positioned after the ground-truth text token;
acquiring an in-use dataset including both the in-use textual data and the in-use audio data;
generating, using the speaker change model, the second in-use sequence of tokens based on the combination of the in-use audio data and the in-use textual data,
the second in-use sequence of tokens including an in-use text token, an in-use punctuation token positioned after the in-use text token, and an in-use speaker change token positioned after the in-use punctuation token;
generating a synthetic audio content based on the second in-use sequence of tokens.

9. The method of claim 8, wherein:
the ground-truth punctuation token is positioned immediately after the ground-truth text token;
the ground-truth speaker change token is positioned immediately after the second ground-truth punctuation token;
the in-use punctuation token is positioned immediately after the in-use text token; and
the in-use speaker change token is positioned immediately after the in-use punctuation token.

10. A server for training a model, the server comprising at least one processor and at least one non-transitory computer-readable memory storing executable instructions, which, when executed by the at least one processor cause the server to:
acquire a punctuation training dataset including a first input and a first label,
the first input including both audio data and textual data representative of a speaker's utterance, the first label including a sequence of ground-truth tokens,
the sequence of ground-truth tokens including (i) a ground-truth text token indicative of a word and (ii) a ground-truth punctuation token indicative of a punctuation, the ground-truth punctuation token positioned after the ground-truth text token;
train the model using the punctuation training dataset for generating an in-use sequence of tokens based on a combination of in-use audio data and in-use textual data, thereby generating a punctuation trained model;
acquire a speaker change training dataset including a second input and a second label,
the second input including second audio data and second textual data representative of utterance of more than one speaker, the second label including a second sequence of ground-truth tokens,
the second sequence of ground-truth tokens including (i) a second ground-truth text token indicative of a second word, (ii) a second ground-truth punctuation token indicative of a second punctuation, and (iii) a ground-truth speaker change token indicative of a change in speakers, the ground-truth speaker change token being positioned after the second ground-truth punctuation token;
fine-tune the punctuation trained model using the speaker change training dataset for generating a second in-use sequence of tokens based on the combination of the in-use audio data and the in-use textual data, thereby generating a speaker change model;
acquire an in-use dataset including both the in-use textual data and the in-use audio data;
generate, using the speaker change model, the second in-use sequence of tokens based on the combination of the in-use audio data and the in-use textual data,
the second in-use sequence of tokens including an in-use text token, an in-use punctuation token positioned after the in-use text token, and an in-use speaker change token positioned after the in-use punctuation token; and
generate a synthetic audio content based on the second in-use sequence of tokens.

11. The server of claim 10, wherein the speaker change model includes an audio sub-model, a text sub-model, and a third sub-model, the generating the second in-use sequence of tokens including:
generating, using the audio sub-model, an in-use sequence of audio embeddings based on the in-use audio data;
generating, using the text sub-model, an in-use sequence of text embeddings based on the in-use textual data;
generating a concatenated intermediate output using the in-use sequence of audio embeddings and the in-use sequence of text embeddings; and
generating, using the third sub-model, the second in-use sequence of tokens using the concatenated intermediate output.

12. The server of claim 11, wherein the audio sub-model is a WavLM model.

13. The server of claim 11, wherein the text sub-model is a mT5 model.

14. The server of claim 11, wherein the third sub-model is a transformer model.

15. The server of claim 10, wherein the at least one processor further causes the server to:
generate, using a speech-to-text model, the textual data based on the audio data;
generate, using the speech-to-text model, the second textual data based on the second audio data; and
generate, using a speech-to-text model, the in-use textual data based on the in-use audio data.

16. The server of claim 10, wherein:
the ground-truth punctuation token is positioned immediately after the ground-truth text token;
the ground-truth speaker change token is positioned immediately after the second ground-truth punctuation token;
the in-use punctuation token is positioned immediately after the in-use text token; and
the in-use speaker change token is positioned immediately after the in-use punctuation token.
